(19) United States
(12) Patent Application Publication
(10) Pub. No.: US 2026/0014632 A1
(43) Pub. Date: Jan. 15, 2026

(54) SAW BLADE

(71) Applicant: MILWAUKEE ELECTRIC TOOL CORPORATION, Brookfield, WI (US)

(72) Inventors: Peter R. Heath, Wauwatosa, WI (US); Bryan C. Ward, Wauwatosa, WI (US); Christopher J. Rechlin, Menomonee Falls, WI (US); Austin J. Kazda, Wauwatosa, WI (US); Matthew B. Lois, Oconomowoc, WI (US)

(21) Appl. No.: 19/256,262

(22) Filed: Jul. 1, 2025

Related U.S. Application Data
(63) Continuation of application No. 17/858,280, filed on Jul. 6, 2022, now Pat. No. 12,377,481.
Application No. 17/858,280 is a continuation of application No. 16/611,433, filed on Nov. 6, 2019, now Pat. No. 11,413,693.
(60) Provisional application No. 62/506,716, filed on May 16, 2017.

(51) Int. Cl. B23D 61/12; B23D 49/16; B23D 51/10; B27B 33/02

(52) U.S. Cl. CPC B23D 61/121; B23D 61/123; B23D 49/162; B23D 51/10; B27B 33/02

(57) ABSTRACT

A saw blade includes a cutting portion having consecutive first, second, and third cutting teeth. Each cutting tooth includes a rake surface, a relief surface, and a tip. The first cutting tooth includes a protrusion extending from the relief surface of the first cutting tooth. The cutting portion includes a first gullet positioned between the first cutting tooth and the second cutting tooth and a second gullet sized differently than the first gullet positioned between the second cutting tooth and the third cutting tooth. The cutting portion includes a first pitch extending over the first gullet from the tip of the first cutting tooth to the tip of the second cutting tooth. The cutting portion includes a second pitch different than the first pitch extending over the second gullet from the tip of the second cutting tooth to the tip of the third cutting tooth.

### CROSS-REFERENCE TO RELATED APPLICATIONS

This application is a continuation of U.S. patent application Ser. No. 17/858,280, filed on Jul. 6, 2022, which is a continuation of U.S. patent application Ser. No. 16/611,433, filed on Nov. 6, 2019, now U.S. Pat. No. 11,413,693, which is a national phase filing under 35 U.S.C. 371 of International Application No. PCT/US2018/032861 filed on May 16, 2018, which claims priority to U.S. Provisional Patent Application No. 62/506,716, filed on May 16, 2017, the entire contents of all of which are incorporated herein by reference.

### BACKGROUND

The present invention relates to saw blades and, more particularly, to saw blades for use with power tools.

### SUMMARY

Saw blades, such as reciprocating saw blades, are used for cutting wood, metal, plastics, and other materials. A saw blade typically includes a body, one or more attachment portions, and a cutting portion. The cutting portion comprises a plurality of teeth made up of one or more tooth forms. Tooth forms on saw blades are a major factor in the durability, cost, speed of cutting, and accuracy and quality of cuts made. Each tooth typically includes a tip, a relief face, a rake face, and a gullet. The teeth are generally separated by a pitch length (otherwise identified as the number of teeth per inch (TPI)). Some tooth forms vary along the length of the saw blade or include portions having varied teeth. In some tooth forms, a nail may become lodged in the gullet of a tooth during operation, thereby breaking or otherwise damaging the tooth.

In one aspect, a saw blade for use with a power tool includes a body defining a longitudinal axis and an attachment portion coupled to the body. The attachment portion includes a tang and an aperture configured to couple to the power tool. The saw blade also includes a cutting portion formed on the body. The cutting portion includes consecutive first, second, and third cutting teeth. The first, second, and third cutting teeth each includes a rake surface, a relief surface, and a tip positioned between the rake and relief surfaces. The first cutting tooth includes a protrusion extending from an end of the relief surface of the first cutting tooth. The second cutting tooth does not include a protrusion on the relief surface of the second cutting tooth. The cutting portion includes a first gullet positioned between the first cutting tooth and the second cutting tooth. The cutting portion includes a second gullet sized differently than the first gullet positioned between the second cutting tooth and the third cutting tooth. The cutting portion includes a first pitch extending over the first gullet from the tip of the first cutting tooth to the tip of the second cutting tooth. The cutting portion includes a second pitch different than the first pitch extending over the second gullet from the tip of the second cutting tooth to the tip of the third cutting tooth.

In another aspect, a saw blade for use with a power tool includes a body and an attachment portion coupled to the body and configured to couple to the power tool. The saw blade also includes a cutting portion formed on the body. The cutting portion includes consecutive first, second, and third cutting teeth. The first, second, and third cutting teeth each includes a rake surface, a relief surface, and a tip positioned between the rake and relief surfaces. The first cutting tooth includes a protrusion extending from an end of the relief surface of the first cutting tooth. The second cutting tooth does not include a protrusion on the relief surface of the second cutting tooth. The cutting portion includes a first gullet positioned between the first cutting tooth and the second cutting tooth. The cutting portion includes a second gullet positioned between the second cutting tooth and the third cutting tooth. The cutting portion includes a first pitch extending over the first gullet from the tip of the first cutting tooth to the tip of the second cutting tooth. The cutting portion includes a second pitch different than the first pitch extending over the second gullet from the tip of the second cutting tooth to the tip of the third cutting tooth.

In yet another aspect, a saw blade for use with a power tool includes a body and an attachment portion coupled to the body and configured to couple to the power tool. The saw blade also includes a cutting portion formed on the body. The cutting portion includes consecutive first, second, and third cutting teeth. The first, second, and third cutting teeth each includes a rake surface, a relief surface, and a tip positioned between the rake and relief surfaces. The first cutting tooth includes a protrusion extending from an end of the relief surface of the first cutting tooth. The second cutting tooth does not include a protrusion on the relief surface of the second cutting tooth. The cutting portion includes a first gullet positioned between the first cutting tooth and the second cutting tooth. The cutting portion includes a second gullet sized differently than the first gullet positioned between the second cutting tooth and the third cutting tooth.

Other aspects of the invention will become apparent by consideration of the detailed description and accompanying drawings.

### BRIEF DESCRIPTION OF THE DRAWINGS

FIG. 1 is a perspective view of a saw blade according to one embodiment of the invention.

FIG. 2 is a side view of the saw blade shown in FIG. 1.

FIG. 3 is an enlarged side view of a portion of the saw blade shown in FIG. 1.

FIG. 4 is an enlarged side view of the portion of the saw blade shown in FIG. 3, the saw blade cutting through a work piece having nails extending therethrough.

FIG. 5 is a perspective view of a reciprocating saw.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Terms of degree, such as “substantially,” “about,” “approximately,” etc. are understood by those of ordinary skill to refer to reasonable ranges outside of the given value, for example, general tolerances associated with manufacturing, assembly, and use of the described embodiments.

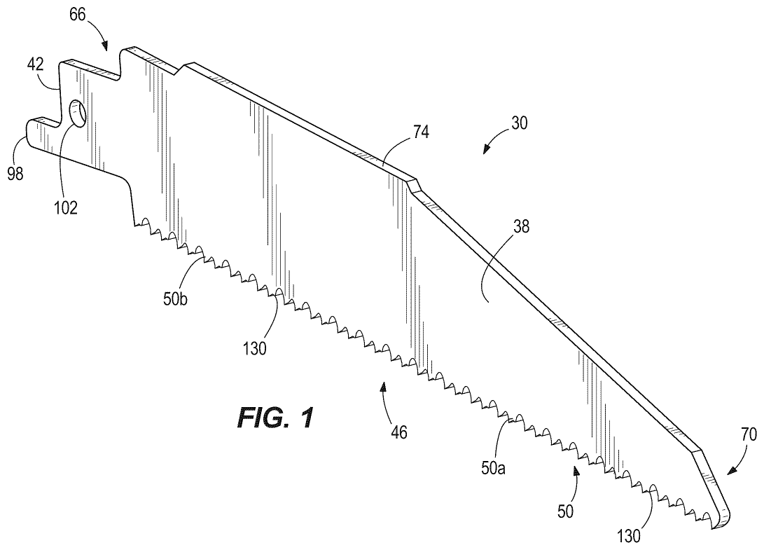

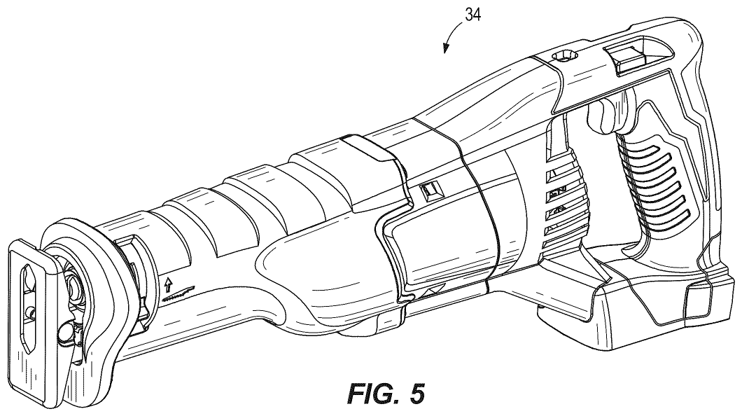

FIGS. 1-3 illustrate a saw blade 30 according to one embodiment of the invention. The illustrated saw blade 30 is a multi-material, reciprocating saw blade for use with a power tool such as, for example, a reciprocating saw 34 (FIG. 5). Many saw blades are specifically engineered for a particular material, such as clean wood, nail embedded wood, or metal. Each of these blades can have very different tooth form characteristics. For example, a multi-material blade typically used in general purpose demolition cutting needs to have exceptional durability cutting through a wide range of materials, including ferrous and non-ferrous metals, plastics, and nail-embedded wood, while balancing the tradeoffs of various tooth form characteristics relative to speed, accuracy, and quality.

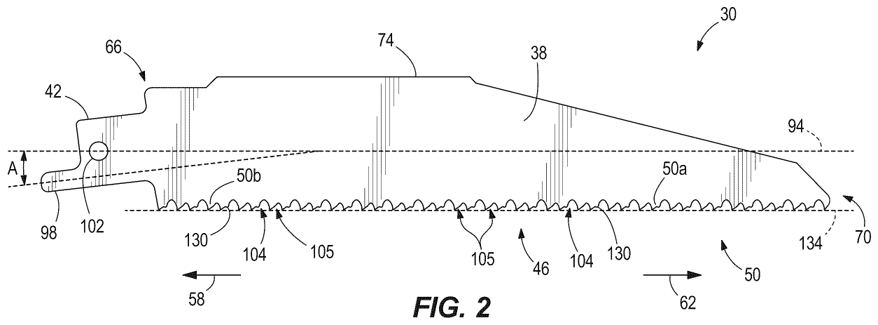

The saw blade 30 includes a body 38, an attachment portion 42 for coupling the blade 30 to the reciprocating saw 34, and a cutting portion 46 having a plurality of cutting teeth 50. In the illustrated embodiment, the body 38, the attachment portion 42, and the cutting portion 46 are all integrally formed as a single piece such that the saw blade 30 is a unitary structure. In some embodiments, the saw blade 30 may be a bi-metal saw blade. In such embodiments, a majority of the body 38 may be formed of a first, softer material (e.g., spring steel, etc.), and an edge section of the body 38 where the cutting teeth 50 are formed may be formed of a second, harder material (e.g., high speed steel, carbide, etc.). The two materials may be joined (e.g., welded, brazed, etc.) together to create the saw blade 30. During operation, the saw blade 30 is reciprocated in a cutting direction 58 and a return direction 62 (FIG. 2) to cut through a work piece. In some embodiments, the saw 34 and the blade 30 may be used to cut through work pieces composed of wood having nails extending through or embedded therein as described in more detail below. In other embodiments, the work piece may be metal, plastic, etc.

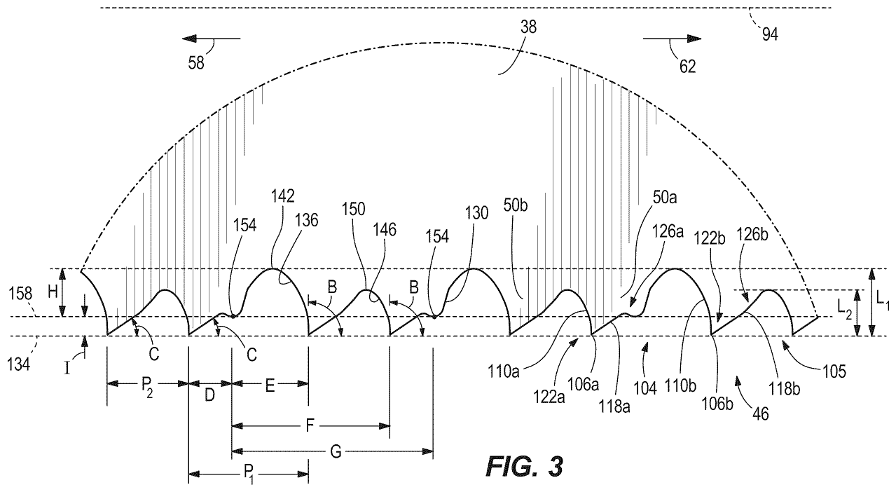

The body 38 includes a first end portion 66 and a second end portion 70. The attachment portion 42 is coupled to (e.g., formed at) the first end portion 66 of the body 38 opposite the second end portion 70. A back edge 74 extends between the attachment portion 42 and the second end portion 70 on a top portion of the body 38 opposite the cutting portion 46. The body 38 also defines a longitudinal axis 94 (FIGS. 2 and 3) extending through the first end portion 66 and the second end portion 70.

The attachment portion 42 extends from the first end portion 66 of the body 38 and includes a tang 98 and an aperture 102. The tang 98 and the aperture 102 are configured to engage a blade clamp of the reciprocating saw 34 to securely and releasably couple the blade 30 to the saw 34. As shown in FIG. 2, the illustrated attachment portion 42 is angled relative to the longitudinal axis 94 by a tang angle A. In the illustrated embodiment, the tang angle A is about 6.5 degrees. In other embodiments, the tang angle A may be about 5 degrees. In further embodiments, the tang angle A may be larger or smaller than 5 degrees.

Referring to FIGS. 2 and 3, the cutting teeth 50 define a tooth form on the body 38. The cutting teeth 50 include first cutting teeth 50a and second cutting teeth 50b. The illustrated cutting teeth 50 also include a first gullet 104 and a second gullet 105 positioned between consecutive first cutting teeth 50a and second cutting teeth 50b. The illustrated tooth form includes a variable pitch (e.g., different distances between adjacent cutting teeth 50). In the illustrated embodiment, a first pitch P₁ that extends over one of the first gullets 104 from a first tip 106a of one cutting tooth 50a to a second tip 106b of an adjacent cutting tooth 50b is about 0.137 inches. As such, the first pitch P₁ equates to 7.3 teeth per inch (TPI). In other embodiments, the first pitch P₁ may be about 0.143 inches (e.g., about 7 TPI). In addition, a second pitch P₂ that extends over one of the second gullets 105 from the first tip 106a of one cutting tooth 50a to the second tip 106b of an adjacent cutting tooth 50b is about 0.093 inches (e.g., about 10.75 TPI). In other embodiments, the second pitch P₂ may be about 0.091 inches (e.g., about 11 TPI). In further embodiments, the first pitch P₁ may be greater than or less than 0.143 inches so that a TPI associated with the first pitch P₁ may be greater than or less than 7 TPI. In yet further embodiments, the second pitch P₂ may be greater than or less than 0.091 inches so that a TPI associated with the second pitch P₂ may be greater than or less than 11 TPI. In yet further embodiments, the first pitch P₁ may be between about 5 TPI and about 9 TPI, and the second pitch P₂ may be between about 9 TPI and about 13 TPI. In the illustrated embodiment, the cutting teeth 50 are unset such that the teeth 50 extend straight from the body 38. In other embodiments, some or all of the teeth 50 may be bent or “set” at various angles relative to a hypothetical plane defined by a side surface of the body 38. The distances and angles identified herein refer to a saw blade in which the cutting teeth are unset. However, it should be readily apparent that a saw blade may be designed according to the disclosed dimensions with unset cutting teeth, and the cutting teeth may ultimately be set as desired during manufacture.

With reference to FIG. 3, each first cutting tooth 50a includes a first rake face 110a extending from the first tip 106a toward the longitudinal axis 94, a first relief surface 118a extending from the first tip 106a and having a first end 122a that is closer to the attachment portion 42 than a second end 126a of the first relief surface 118a in a direction along the longitudinal axis 94, and a protrusion 130 extending from the second end 126a of the first relief surface 118a. Likewise, each second cutting tooth 50b includes a second rake face 110b extending from the second tip 106b toward the longitudinal axis 94, and a second relief surface 118b extending from the second tip 106b and having a first end 122b that is closer to the attachment portion 42 than a second end 126b of the second relief surface 118b in a direction along the longitudinal axis 94. However, the second cutting teeth 50b do not include the protrusions 130 so that the protrusions 130 are positioned on every other cutting tooth 50. The first and second tips 106a, 106b of the cutting teeth 50 define a plane 134 that is generally parallel to the longitudinal axis 94.

In some embodiments, the first cutting teeth 50a may include first carbide tips 106a, and the second cutting teeth 50b may include second carbide tips 106b. In such embodiments, the carbide tips 106a, 106b may be separate pieces that are welded, brazed, or otherwise secured to the bodies of the cutting teeth 50a, 50b. In other embodiments, the cutting tips 106a, 106b may be integrally formed of the same material as the rest of the cutting teeth 50a, 50b.

Each first and second rake face 110a, 110b extends from the corresponding tip 106a, 106b at a rake angle B relative to the plane 134 (FIG. 3). The rake angle B of each cutting tooth 50, measured through the corresponding cutting tooth 50, is a positive rake angle (i.e., an angle less than 90 degrees). In the illustrated embodiment, the rake angle B of each cutting tooth 50 is about 92.1 degrees. In other embodiments, the rake angle B may be larger or smaller, or each rake face 110a, 110b may extend at a negative rake angle (i.e., an angle greater than 90 degrees relative to the plane 134). In general, a saw blade including a negative rake angle B is more durable than a saw blade including a positive rake angle B, but the saw blade including the positive rake angle B will cut quicker than the saw blade including the negative rake angle B. In further embodiments, the first rake face 110a may include a different rake angle B relative to a rake angle B of the second rake face 110b. In some embodiments, one of the either the first cutting tooth 50a or the second cutting tooth 50b may have a positive rake angle, and the other of either the first cutting tooth 50a or the second cutting tooth 50b may have a negative rake angle. In such embodiments, the rake angles B of the rake faces 110a, 110b may alternate along the length of the cutting portion 46 between positive and negative.

Each of the first gullets 104 is defined by a first gullet surface 136 extending between the protrusion 130 of a first cutting tooth 50a and the second rake face 110b of an adjacent second cutting tooth 50b. The first gullet surface 136 is generally a curved surface. Each of the first gullets 104 has a first gullet depth L₁, or first tooth height, measured from a base 142 of the first gullet 104 to the plane 134 of the cutting teeth 50. In the illustrated embodiment, the first gullet depth L₁ is about 0.075 inches. In the illustrated embodiment, the first gullet depth L₁ is about 55% of the first pitch P₁. In other embodiments, the first gullet depth L₁ is between about 45% and about 65% of the first pitch P₁.

Each of the second gullets 105, which is smaller (e.g., in volume) than the first gullets 104, is defined by a second gullet surface 146 extending between the second end 126b of a second cutting tooth 50b and the first rake face 110a of an adjacent first cutting tooth 50a (FIG. 3). The second gullet surface 146 is generally a curved surface. Each of the second gullets 105 has a second gullet depth L₂, or second tooth height, measured from a base 150 of the second gullet 105 to the plane 134 of the cutting teeth 50. The second gullet depth L₂ is less than the first gullet depth L₁. In the illustrated embodiment, the second gullet depth L₂ is about 0.051 inches. The illustrated second gullet depth L₂ is about 55% of the second pitch P₂. In other embodiments, the second gullet depth L₂ is between about 45% and about 65% of the second pitch P₂.

The first and second relief surface 118a, 118b of each cutting tooth 50 extends generally toward the longitudinal axis 94 and toward the second end portion 70. The first and second relief surfaces 118a, 118b are oriented at relief angles C relative to the plane 134 (FIG. 3). In the illustrated embodiment, the relief angle C of each cutting tooth 50 is about 34 degrees. In other embodiments, the relief angles C may be larger or smaller. In further embodiments, the first relief surface 118a may include a different relief angle C relative to the relief angle C of the second relief surface 118b. The first relief surface 118a also includes a first relief length measured from the first end 122a (e.g., the first tip 106a) to the second end 126a (e.g., a beginning of the protrusion 130), and the second relief surface 118b includes a second relief length measured from the first end 122b (e.g., the second tip 106b) to the second end 126b (e.g., a beginning of the second gullet 105). In one embodiment, the first relief length of the first relief surface 118a is the same as the second relief length of the second relief surface 118b. In other embodiments, the first relief length may be different than the second relief length.

With continued reference to FIG. 3, the first relief surface 118a of each first cutting tooth 50a is interrupted by the protrusion 130 extending from the second end 126a of the first relief surface 118a. In the illustrated embodiment, an apex 154 of each protrusion 130 is curved such that the protrusions 130 are generally rounded. In other embodiments, the protrusions 130 may have other shapes or forms. The apex 154 of the illustrated protrusion 130 of each first cutting tooth 50a is spaced a first distance D, measured generally parallel to the longitudinal axis 94, from the first tip 106a of the corresponding first cutting tooth 50a. The apex 154 of the illustrated protrusion 130 is spaced a second distance E, measured generally parallel to the longitudinal axis 94, from the second tip 106b of an adjacent second cutting tooth 50b. The second distance E also represents a width of the first gullet 104. The apex 154 of the illustrated protrusion 130 is spaced a third distance F, measured generally parallel to the longitudinal axis 94, from the first tip 106a of an adjacent first cutting tooth 50a. The apex 154 of the illustrated protrusion 130 is spaced a fourth distance G, measured generally parallel to the longitudinal axis 94, from an apex 154 of an adjacent protrusion 130. In the illustrated embodiment, the first distance D is about 0.049 inches, the second distance E is about 0.087 inches, the third distance F is about 0.180 inches, and the fourth distance G is about 0.229 inches. In other embodiments, the first distance D may be between about 0.03 inches and about 0.07 inches, the second distance E may be between about 0.07 inches and about 1.1 inches, the third distance F may be between about 0.16 inches and about 0.2 inches, and the fourth distance G may be between about 0.21 inches and about 0.25 inches.

The apexes 154 of the protrusions 130 of the first cutting teeth 50a also define a plane 158 that is generally parallel to the longitudinal axis 94 and to the plane 134 defined by the first and second tips 106a, 106b of the cutting teeth 50. In the illustrated embodiment, the plane 158 is spaced a fifth distance H, measured generally perpendicular to the longitudinal axis 94, from the base 142 of the first gullet 104. In the illustrated embodiment, the fifth distance H is about 0.0543 inches. In other embodiments, the fifth distance H may be between about 0.05 inches and about 0.07 inches. In some embodiments, a ratio of the fifth distance H over the first distance L₁ is about 0.724 to 1. In other embodiments, the ratio of the fifth distance H over the first distance L₁ is between about 0.6 and about 0.8. In some embodiments, a sixth distance I between the plane 134 defined by the first and second tips 106a, 106b and the plane 158 defined by the protrusions 130 is at most 0.021 inches. In the illustrated embodiment, the sixth distance I is about 0.021 inches. Such an arrangement helps inhibit nails from entering the first and second gullets 104, 105 of the cutting teeth 50 during cutting operations, as further discussed below.

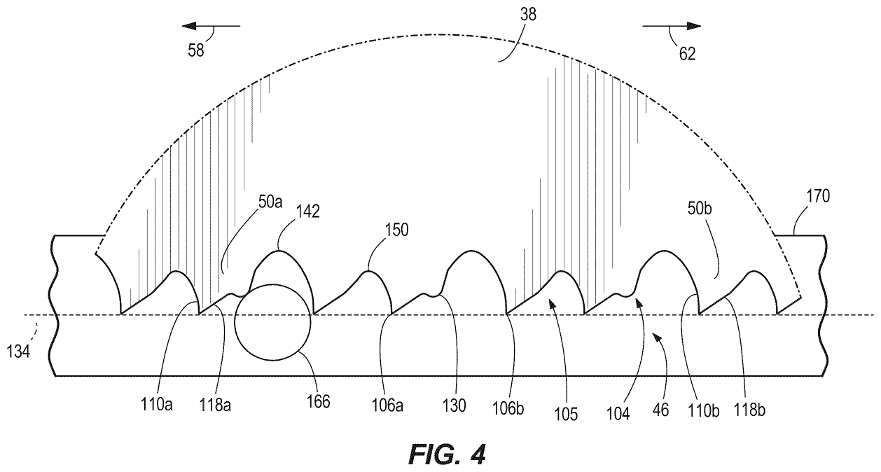

Referring to FIG. 4, the protrusions 130 of the first cutting teeth 50a inhibit nails 166, or other hard objects, imbedded in a work piece 170 from entering the first gullets 104 and contacting the second rake faces 110b of the second cutting teeth 50b during cutting operations. As the saw blade 30 moves in the cutting direction 58 (to the left in FIG. 4), the first and second tips 106a, 106b of the cutting teeth 50 engage and cut through the work piece 170. The protrusions 130 are hidden behind the first tips 106a of adjacent first cutting teeth 50a such that the protrusions 130 do not cut the work piece 170 during the cutting operation.

When a typical saw blade encounters the nail 166, the nail 166 would move into a gullet so that an adjacent cutting tooth (i.e., the rake face) may shear all or most of the nail 166 for the adjacent cutting tooth to move past the nail 166 in the cutting direction 58. Such contact may chip, break, or otherwise damage the cutting tooth, significantly reducing the usable life of the saw blade. However, as shown in FIG. 4, the protrusions 130 limit an amount of the nail 166 impacting the second rake faces 110b. As the saw blade 30 moves in the cutting direction 58, the nail 166 contacts one of the protrusions 130 before contacting the adjacent second cutting tooth 50b. The protrusion 130 displaces (e.g., lifts) the saw blade 30, which repositions the nail 166 with respect to the first gullet 104 in an improved cutting position. In the improved cutting position, the protrusion 130 inhibits a majority of the nail 166 from entering the first gullet 104 and the second tip 106b is allowed to cut into a smaller portion of the nail 166. In other words, minimal impact occurs between the nail 166 and the second rake face 110b. Furthermore, the protrusions 130 also allow for the nail 166 to skip over the second gullets 105 to inhibit the nail 166 from entering the second gullets 105. For example, the second gullets 105 are able to move past the nail 166 after the protrusions 130 displace the saw blade 30 away from the nail 166. In other words, the nail 166 skips from one protrusion 130 over the second gullet 105 to an adjacent protrusion 130. As such, in some embodiments, the nail 166 does not impact the first rake face 110a of the first cutting tooth 50a. When the saw blade 30 is reciprocated in the return direction 62 (to the right in FIG. 4), the nail 166 can ride along the corresponding relief surface 118a, 118b and over the tips 106a, 106b.

In the illustrated embodiment, the protrusions 130 of the first cutting teeth 50a and the second gullets 105 are designed to inhibit a standard framing nail having a 0.131 inch diameter from entering the first and second gullets 104, 105. In other embodiments, the protrusions 130 may be optimized to inhibit other size nails from entering the first and second gullets 104, 105. The protrusions 130 are sized and positioned to inhibit more than about 21% of the nail 166 from entering the area between the plane 134 of the first tip 106a and the base 142 of the first gullet 104. Such a configuration results in an increase in durability compared to a similar saw blade without protrusions on the cutting teeth. As used herein, the term ‘durability’ refers to the average number of cuts a saw blade makes before fracturing a cutting tooth. In some embodiments, the term ‘durability’ may refer to the average number of fractured teeth in a cut zone of the saw blade after one cut of the saw blade.

Because the saw blade 30 includes a high TPI (e.g., equal to or greater than 7 TPI), about half of the cutting teeth 50 include the protrusions 130 to balance the durability of the saw blade 30 with the cutting efficiency of the saw blade 30. The cutting efficiency of the saw blade 30 (e.g., the rate of which the saw blade 30 cuts through the work piece 170) is dependent upon gullet volume of the first and second gullets 104, 105 to extract cut material (e.g., chips) away from the work piece 170. For example, if the saw blade 30 includes more protrusions 130, the durability of the saw blade 30 increases, but the total gullet volume of the saw blade 30 will decrease, causing a decrease in efficiency of cutting the work piece 170 (e.g., a slower cut of the work piece 170). However, if the saw blade 30 includes fewer protrusions 130, the durability of the saw blade 30 decreases, but the total gullet volume of the saw blade 30 will increase, causing an increase in efficiency of cutting the work piece 170 (e.g., a faster cut of the work piece 170).

Although particular embodiments embodying independent aspects of the present invention have been shown and described, other alternative embodiments will become apparent to those skilled in the art and are within the intended scope of the independent aspects of the invention. For example, although the above saw blade tooth forms have been described with reference to saw blades for use with reciprocating saws that alternately move the saw blades in cutting directions and return directions, the tooth forms may be used on other types of saw blades having a linear edge, including band saw blades and jig saw blades.

Various features and advantages of the disclosure are set forth in the following claims.

What is claimed is:

1. A saw blade for use with a power tool, the saw blade comprising:
a body; and
a cutting portion formed on the body, the cutting portion including consecutive first, second, and third cutting teeth, a first gullet positioned between the first cutting tooth and the second cutting tooth, and a second gullet positioned between the second cutting tooth and the third cutting tooth, the first, second, and third cutting teeth each including a rake surface, a relief surface, and a tip positioned between the rake and relief surfaces, the first cutting tooth including a protrusion extending from an end of the relief surface of the first cutting tooth, the second cutting tooth does not include a protrusion on the relief surface of the second cutting tooth;
wherein the protrusion of the first cutting tooth is configured to inhibit a nail from entering the first gullet and from entering the second gullet during cutting operations.

2. The saw blade of claim 1, wherein the third cutting tooth includes a protrusion extending from an end of the relief surface of the third cutting tooth.

3. The saw blade of claim 2, wherein the third cutting tooth has the same shape as the first cutting tooth.

4. The saw blade of claim 1, wherein the second gullet is smaller than the first gullet.

5. The saw blade of claim 4, wherein the tips of the first, second, and third cutting teeth define a tip plane, wherein the first gullet includes a gullet depth measured from a base of the first gullet to the tip plane, wherein the second gullet includes a second gullet depth measured from a base of the second gullet to the tip plane, and wherein the second gullet depth is less than the first gullet depth.

6. The saw blade of claim 1, wherein the cutting portion includes a first pitch extending over the first gullet from the tip of the first cutting tooth to the tip of the second cutting tooth, and a second pitch extending over the second gullet from the tip of the second cutting tooth to the tip of the third cutting tooth, and wherein the second pitch is different than the first pitch.

7. The saw blade of claim 6, wherein the second pitch is less than the first pitch.

8. The saw blade of claim 7, wherein the first pitch is between about 5 TPI and about 9 TPI, and wherein the second pitch is between about 9 TPI and about 13 TPI.

9. The saw blade of claim 1, wherein the body defines a longitudinal axis, wherein the protrusion of the first cutting tooth includes an apex defining an apex plane parallel to the longitudinal axis, and wherein the tip of the first cutting tooth and the end of the relief surface of the first cutting tooth are positioned on opposite sides of the apex plane.

10. The saw blade of claim 1, wherein the protrusion is rounded.

11. A saw blade for use with a power tool, the saw blade comprising:
a body; and
a cutting portion formed on the body, the cutting portion including consecutive first, second, and third cutting teeth, the first, second, and third cutting teeth each including a rake surface, a relief surface, and a tip positioned between the rake and relief surfaces, the first cutting tooth including a protrusion extending from an end of the relief surface of the first cutting tooth, the second cutting tooth does not include a protrusion on the relief surface of the second cutting tooth;
wherein the protrusion of the second cutting tooth is configured to inhibit a nail from contacting the rake surface of the second cutting tooth and from contacting the rake surface of the third cutting tooth during a cutting operation.

12. The saw blade of claim 11, wherein the third cutting tooth includes a protrusion extending from an end of the relief surface of the third cutting tooth.

13. The saw blade of claim 11, wherein the second gullet is smaller than the first gullet.

14. The saw blade of claim 13, wherein the tips of the first, second, and third cutting teeth define a tip plane, wherein the first gullet includes a gullet depth measured from a base of the first gullet to the tip plane, wherein the second gullet includes a second gullet depth measured from a base of the second gullet to the tip plane, and wherein the second gullet depth is less than the first gullet depth.

15. The saw blade of claim 11, wherein the cutting portion includes a first pitch extending over the first gullet from the tip of the first cutting tooth to the tip of the second cutting tooth, and a second pitch extending over the second gullet from the tip of the second cutting tooth to the tip of the third cutting tooth, and wherein the second pitch is less than the first pitch.

16. The saw blade of claim 15, wherein the first pitch is between about 5 TPI and about 9 TPI, and wherein the second pitch is between about 9 TPI and about 13 TPI.

17. The saw blade of claim 11, wherein the body defines a longitudinal axis, wherein the protrusion of the first cutting tooth includes an apex defining an apex plane parallel to the longitudinal axis, and wherein the tip of the first cutting tooth and the end of the relief surface of the first cutting tooth are positioned on opposite sides of the apex plane.

18. The saw blade of claim 11, wherein the protrusion is rounded.

19. A saw blade for use with a power tool, the saw blade comprising:
a body defining a longitudinal axis;
an attachment portion coupled to the body, the attachment portion including a tang and an aperture configured to couple to the power tool; and
a cutting portion formed on the body, the cutting portion including consecutive first, second, and third cutting teeth, a first gullet positioned between the first cutting tooth and the second cutting tooth, and a second gullet positioned between the second cutting tooth and the third cutting tooth, the first, second, and third cutting teeth each including a rake surface, a relief surface, and a tip positioned between the rake and relief surfaces, the first cutting tooth including a protrusion extending from an end of the relief surface of the first cutting tooth, the second cutting tooth does not include a protrusion on the relief surface of the second cutting tooth;
wherein the cutting portion includes a first pitch extending over the first gullet from the tip of the first cutting tooth to the tip to the second cutting tooth, and a second pitch extending over the second gullet from the tip of the second cutting tooth to the tip of the third cutting tooth;
wherein the second pitch is less than the first pitch; and
wherein the protrusion of the first cutting tooth is configured to inhibit a nail from entering the first gullet and contacting the rake surface of the second cutting tooth, and from entering the second gullet and contacting the rake surface of the third cutting tooth during cutting operations.

20. The saw blade of claim 19, wherein the first pitch is between about 5 TPI and about 9 TPI, and wherein the second pitch is between about 9 TPI and about 13 TPI.
